(19) United States
(12) Patent Application Publication
(10) Pub. No.: US 2013/0174638 A1
(43) Pub. Date: Jul. 11, 2013

(54) METHOD OF TESTING WEAR RESISTANCE OF WIRE COVERING MATERIAL

(71) Applicant: Takeshi SATO, Yokkaichi-city (JP)

(72) Inventor: Takeshi SATO, Yokkaichi-city (JP)

(73) Assignee: SUMITOMO WIRING SYSTEMS, LTD., Mie (JP)

(21) Appl. No.: 13/611,772

(22) Filed: Sep. 12, 2012

(30) Foreign Application Priority Data
Jan. 11, 2012 (JP) 2012-002962

(51) Int. Cl. G01N 3/56

(52) U.S. Cl. 73/7

(57) ABSTRACT

A method of testing wear resistance of a wire coating material includes (a) preparing a wire coating material as a specimen; and (b) relatively moving a wear member with respect to the specimen in a state where the wear member is in contact with the specimen. A first value associated with a relative movement amount of the wear member with respect to the specimen is obtained. A second value associated with a wear amount of the specimen is obtained. A value that evaluates wear resistance is calculated by dividing the first value by the second value. The wear resistance of the wire coating material is evaluated based on a degree of the value.

### CROSS-REFERENCE TO RELATED APPLICATIONS

The present application claims priority under 35 U.S.C. §119 of Japanese Application No. 2012-002962, filed on Jan. 11, 2012, which is herein expressly incorporated by reference in its entirety.

### BACKGROUND OF THE INVENTION

1. Field of the Invention

The present invention relates to a method of testing wear resistance of a wire covering material.

2. Description of Related Art

Non-Patent Literature 1 discloses a method of testing wear resistance of a wire covering material. In Non-Patent Literature 1, an electric wire is used as a specimen, with which a wear tape is brought into contact in a state where a load is exerted by a weight. In this state, the wear tape is moved and a length until a conductive body and the tape come in contact with each other is defined as a wear resistant value.

[Non-Patent Literature 1] JISC 3406 6.9 Wear

In Non-Patent Literature 1, however, at least one of a test condition (mass of the weight) and minimum wear resistance to be satisfied is different for each outer diameter of an electric wire. Thus, in order to determine whether or not a certain coating material passes a predetermined level of wear resistance, the wear test above should be performed for each different wire diameter. This requires enormous time and man-hours for evaluation of wear properties.

### SUMMARY OF THE INVENTION

In view of the circumstances above, an object of the present invention is to simplify evaluation of wear resistance of a wire coating material.

To address the circumstances above, a first aspect provides a method of testing wear resistance of a wire coating material, the method including (a) preparing a wire coating material as a specimen; (b) relatively moving a wear member with respect to the specimen in a state where the wear member is in contact with the specimen; (c) obtaining a first value associated with a relative movement amount of the wear member with respect to the specimen in (b); (d) obtaining a second value associated with a wear amount of the specimen in (b); and (e) calculating a value that evaluates wear resistance by dividing the first value by the second value.

A second aspect provides the method of testing the wear resistance of the wire coating material according to the first aspect, in which, in (b), a constant test load is exerted on the specimen and the wear member; and in (d), a value is obtained as the second value by dividing the wear amount of the specimen by the test load.

A third aspect provides the method of testing the wear resistance of the wire coating material according to one of the first and second aspects, in which, in (a), the specimen having a round bar shape is prepared; and in (b), the wear member having a band shape is used; the wear member is fitted along a circumferential surface of a pressing member and the wear member is brought into contact with the specimen in a state where a width direction of the wear member is orthogonal to a longitudinal direction of the specimen; and in this state, the wear member is pulled from between the specimen and the circumferential surface to move the wear member relative to the specimen.

A fourth aspect provides the method of testing the wear resistance of the wire coating material according to one of the first and second aspects, in which, in (a), the specimen having a columnar shape is prepared; and in (b), the specimen and the wear member are opposite to and in contact with each other in a direction along a longitudinal direction of the specimen.

In the method of testing the wear resistance of the wire coating material according to the first aspect, the first value associated with the relative movement amount of the wear member with respect to the specimen is obtained; the second value associated with the wear amount of the specimen is obtained; and the value that evaluates wear resistance is calculated by dividing the first value by the second value. This allows evaluation of the wear resistance with a value least impacted by the size of the specimen. Thus, the wear resistance of the wire coating material can be evaluated readily without a wear resistance test for each wire diameter.

According to the second aspect, the second value is obtained by dividing the wear amount of the specimen by the test load. Thus, even in a case where the test load varies in each wear resistance test, an impact due to the difference in the test load can be eliminated as much as possible.

According to the third aspect, a test can be performed under the test condition defined in JISC 3406.

According to the fourth aspect, the specimen and the wear member are opposite to and in contact with each other in the direction along the longitudinal direction of the specimen in (b). Thus, a wear volume of the specimen can be readily obtained.

### BRIEF DESCRIPTION OF THE DRAWINGS

The present invention is further described in the detailed description which follows, with reference to the noted plurality of drawings by way of non-limiting examples of exemplary embodiments of the present invention, in which like reference numerals represent similar parts throughout the several views of the drawings, and wherein:

FIG. 1 is a view illustrating a process of performing a wear resistance test according to an embodiment;

FIG. 2 is a view illustrating the process of performing the wear resistance test according to the embodiment;

FIG. 3 is a view illustrating a state where a specimen is abraded;

FIG. 4 is a view illustrating an exemplary relationship between a movement length and an abraded volume of a worn member;

FIG. 5 is a view illustrating a process of performing a wear resistance test according to a modification; and

FIG. 6 is a view illustrating an exemplary relationship between an abrasive rate and a load per unit area.

### DETAILED DESCRIPTION OF PREFERRED EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

A method of testing wear resistance of a wire coating material according to an embodiment is described below.

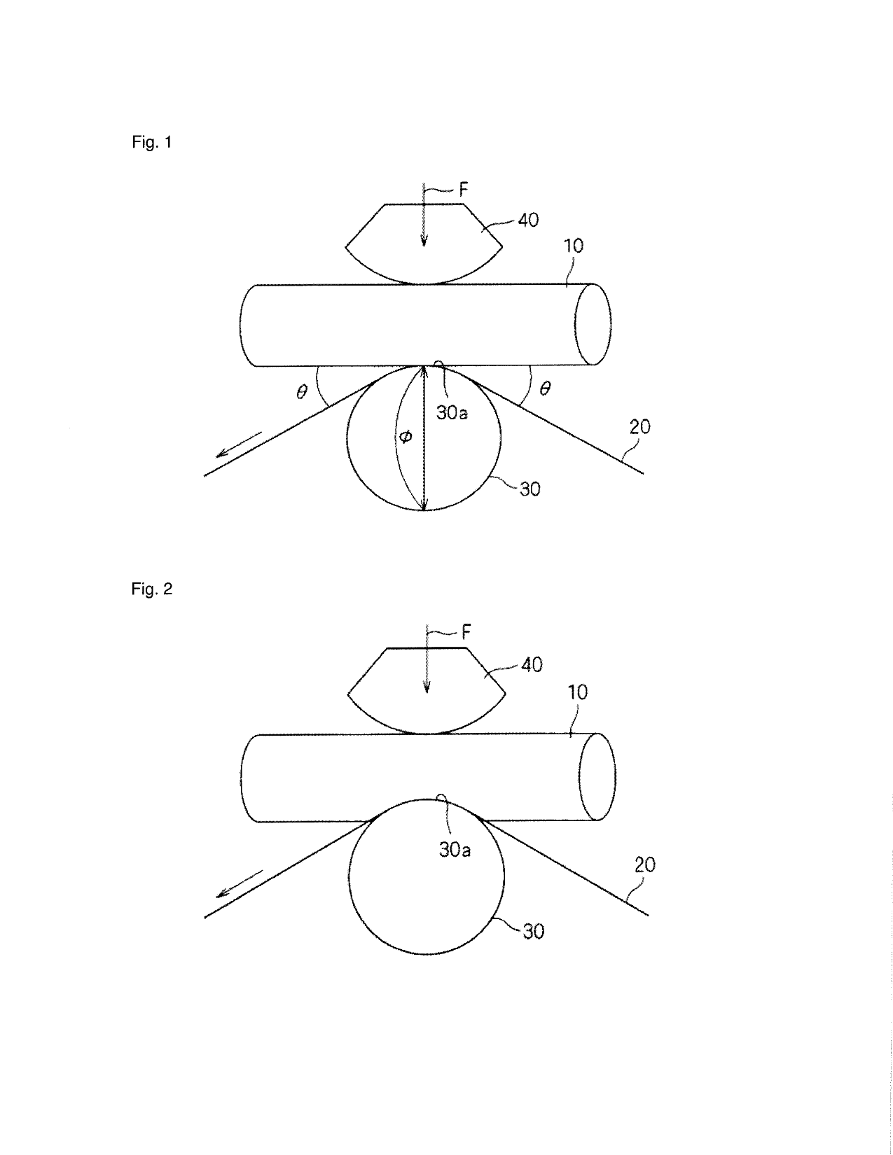

FIGS. 1 and 2 are each a view illustrating a process of performing a wear resistance test according to an embodiment. FIG. 1 illustrates an initial state and FIG. 2 illustrates a state during the test.

The method of testing the wear resistance of the wire coating material tests wear resistance of a wire coating material, in particular, a wire coating material for an automobile. Specifically, the wire includes a strand composed of a single wire or a twisted wire extrusion-coated with a coating portion composed of a resin coating material. The test method tests wear resistance of such a coating material, which is a material to form a coating portion.

To perform the method of testing the wear resistance of the wire coating material, a wire coating material is prepared first as a specimen 10 (process (a)). The specimen 10 is composed of a resin material which is a candidate in selection of a material to form a wire coating portion. The specimen 10 herein is formed into a round bar shape having a circular shape in a cross-sectional view orthogonal to an axis direction. In order to be consistent with the test condition of JISC 3406, it is preferred that the length of the specimen 10 be defined as 900 mm. Of course, the shape of the specimen 10 is not limited to the round bar shape and may be another shape, such as a square bar shape or a rectangular parallelepiped shape.

Then, in a state where a wear member 20 is in contact with the specimen 10, the wear member 20 is moved relative to the specimen 10 (process (b)).

The wear member 20 used herein is a band shaped member having at least one main surface on which an abrasive, such as an alumina abrasive or a silicon carbide abrasive, is bonded with an adhesive. In order to be consistent with the wear test condition defined in JISC 3406, it is preferred that the wear member 20 be #150G as defined in JISR 6251.

In order to be consistent with the wear test condition defined in JISC 3406, it is preferred that the specimen 10 and the wear member 20 be in contact with each other in a state described below.

Specifically, both end portions of the specimen 10 are fixed such that the specimen 10 is provided horizontally. Then, a pressing member 30 is provided below the specimen 10. The pressing member 30 is a member having a circumferential surface 30a and is a short columnar member herein. It is preferred that the diameter ø of the pressing member be 70 mm (curvature radius of the circumferential surface 30a is 35 mm). In a state where the center axis of the pressing member 30 is orthogonal to a longitudinal direction of the specimen 10, the pressing member 30 is provided below the specimen 10 such that the circumferential surface 30a of the pressing member 30 is able to come into contact with a downward outer peripheral surface of the specimen 10. Then, the wear member 20 is fitted along the circumferential surface 30a of the pressing member 30 and a width direction of the wear member 20 is provided orthogonal to the longitudinal direction of the specimen 10. Thus, the wear member 20 is placed between the circumferential surface 30a of the pressing member 30 and the specimen 10 and the wear member 20 is brought into contact with the specimen 10. It is preferred that a portion extending from the wear member 20 between the pressing member 30 and the specimen 10 be provided at an angle θ of 30°, the angle θ being defined relative to the longitudinal direction of the specimen 10.

Furthermore, a weight 40 is provided above the specimen 10 in a location where the pressing member 30 is provided so as to exert a constant test load F on the specimen 10 in accordance with the mass of the weight 40. It is preferred that the mass of the weight 40, specifically, the test load F be the same in a test of each specimen 10. Of course, the mass of the weight 40 may be changed. A method of calculating an evaluation value in this case will be described separately.

In the state above, the wear member 20 is pulled from between the specimen 10 and the circumferential surface 30a, and thus the wear member 20 is moved relative to the specimen 10. In other words, the wear member 20 is pulled in a direction parallel to the longitudinal direction of the specimen 10 as viewed from above. It is preferred that the movement speed of the wear member 20 at this time be 1,500 mm/min.

A method of moving the wear member 20 relative to the specimen 10 in the state where the wear member 20 is in contact with the specimen 10 is not limited to the above example. A possible modification example will be described later.

In the state where the wear member 20 is in contact with the specimen 10 as described above, the wear member 20 is moved relative to the specimen 10, and then the specimen 10 is abraded by the wear member 20 (refer to FIG. 2).

In the process (b) above, a relative movement amount of the wear member 20 with respect to the specimen 10, which herein is a length L for which the wear member 20 is pulled (hereinafter referred to as a movement length L of the wear member 20), is obtained as a first value (process (c)). It is preferred that the length to pull the wear member 20 be 100 mm to 1,000 mm. In order to be consistent with the test condition, it is preferred that the length to pull the wear member 20 be the same in a test of each of various specimens 10.

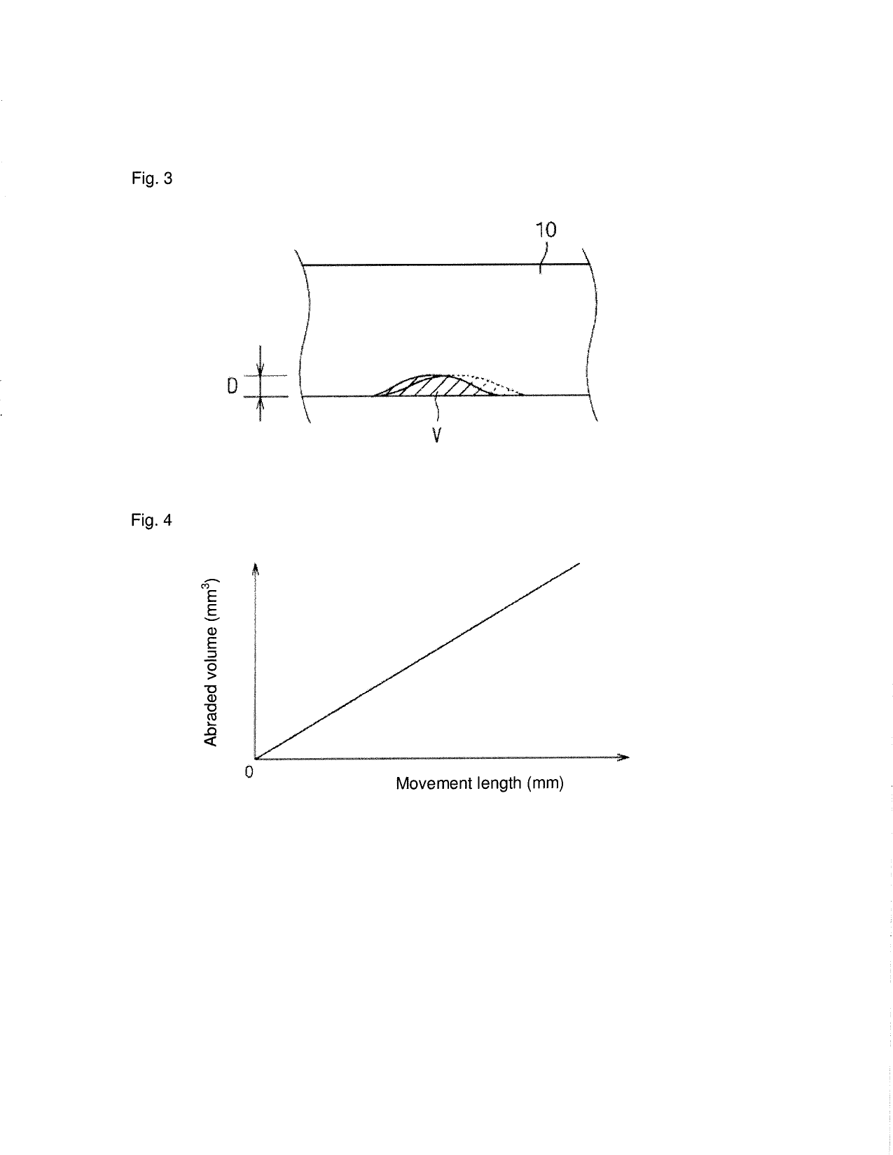

Furthermore, in the process (d) above, a second value is obtained which is associated with a wear amount of the specimen 10. The second value obtained herein is a volume V of the specimen 10 abraded by the wear member 20 (hereinafter sometimes referred to as the abraded volume V), as shown in FIG. 3 (refer to a shaded portion in FIG. 3). The volume V itself can be obtained by an analytical or geometrical method based on the diameter of the specimen 10, the curvature radius of the pressing member 30 (curvature radius of an interface of the portion abraded by the wear member 20), a dimension D abraded by the wear member 20, and the like. Alternatively, the volume V can be obtained by a method in which the portion above is divided into simple shapes, such as cubes, and volumes of the divided portions are added to produce an approximate volume.

The second value associated with the wear amount of the specimen 10 may be the mass of the portion of the specimen 10 abraded by the wear member 20 (difference between the mass of the original specimen 10 and the mass of the tested specimen 10). Alternatively, since the dimension D abraded by the wear member 20 with the lowest portion of the specimen 10 as a reference and the volume V are in a positive correlation, the second value may be the dimension D.

FIG. 4 illustrates an exemplary relationship between the movement length L (mm) of the wear member 20 and the abraded volume V (mm³). With reference to the drawing, the movement length L (mm) of the wear member 20 is proportionate to the abraded volume V (mm³). Thus, the first value above (movement length L of the wear member 20) is divided by the second value (abraded volume V) (i.e., a proportionality factor is calculated), and then the calculated value is used to evaluate wear resistance as a wear coefficient. Specifically, it is expressed as (Wear coefficient)=(Movement length L of the wear member 20)/(Abraded volume V).

The more excellent the wear resistance of the specimen 10 is, the higher the wear coefficient value is, whereas the less excellent the wear resistance of the specimen 10 is, the lower the value is. Thus, the wear resistance of the specimen 10 can be evaluated based on the degree of the wear coefficient.

In a case where the test load F exerted by the weight 40 is constant in each test, there is no problem with evaluating the wear resistance based on the wear coefficient calculated as above. In a case, however, where the test load F exerted by the weight 40 is different in each test, it is preferred to eliminate an impact of the test load F.

The wear amount is proportionate to the movement length L (slip amount) of the wear member 20 above and the test load F. Thus, it is preferred, as the second value, to employ a value calculated by dividing the wear amount of the specimen 10 by the test load F.

In this case, a formula to calculate the wear coefficient above is expressed as (Wear coefficient)=(Movement length L of the wear member 20)/((Abraded volume V)/(Test load F)). This allows evaluation of the wear resistance with the least impact of the test load F even in the case where the test load F is different.

Furthermore, a wear resistance property required by JISC 3406 is converted into the wear coefficient above, which is then compared with the wear coefficient obtained in the experiment above of the target specimen 10. Thus, it can be estimated whether or not the target specimen 10 meets the wear resistance property required by JISC 3406.

In JISC 3406, for instance, an electric wire including a strand of 0.5 sq (mm²) is required to meet a minimum wear resistance of 457 mm in a test with a weight having a mass of 450 g. In a case where an electric wire having an outer diameter of 1.25 mm and a thickness of a coating portion of 0.8 mm (thickness of an outer layer is 0.4 mm) is tested as defined by JISC 3406, a wear amount of the coating portion is 3.39 mm³. The formula to calculate the wear coefficient with each value assigned thereto is as below. The test load F is taken into consideration herein in calculation of the wear coefficient.

(Wear coefficient)=(457 (mm))/((3.39 (mm³))/(450 (g)))=60,664

Accordingly, in the experiment performed on the target specimen 10, if the wear coefficient (with the test load F taken into consideration) obtained as a result exceeds 60,664, it can be estimated that the specimen 10 meets the JIS standard.

The wear coefficient can be obtained in a similar manner to the above with respect to the minimum wear resistance defined for other types. Thus, it can be estimated whether or not the target specimen 10 meets the JIS standard.

According to the method of testing the wear resistance of the wire coating material configured as above, the first value associated with the relative movement amount of the wear member 20 with respect to the specimen 10 is obtained, the second value associated with the wear amount of the specimen 10 is obtained, and the first value is divided by the second value to obtain a value to evaluate the wear resistance. Thus, the wear resistance can be evaluated with a value with the least impact of the size of the specimen 10. This allows quantitative evaluation hardly impacted by the test condition and the like. In addition, the wear resistance of the wire coating material can be evaluated in a simple and quick manner even without the wear resistance test for each wire diameter.

Furthermore, even in the case where the test load F varies in each wear resistance test, the impact due to the difference in the test load F can be eliminated as much as possible since the second value is obtained by dividing the wear amount of the specimen 10 by the test load F. This allows, for example, easy comparison with predefined JISC 3406 and the like.

In addition, the specimen 10 having a round bar shape is prepared and the wear member 20 having a band shape is used. The wear member 20 is fitted along the circumferential surface 30a of the pressing member 30 and the wear member 20 is brought into contact with the specimen 10 in the state where the width direction of the wear member 20 is orthogonal to the longitudinal direction of the specimen 10. In this state, the wear member 20 is pulled from between the specimen 10 and the circumferential surface 30a, and thus the wear member 20 is moved relative to the specimen 10. Thereby, the test can be performed under the condition same as the test condition defined in JISC 3406. This allows appropriate comparison with the wear resistance defined in JISC 3406.

A method of moving the wear member 20 relative to the specimen 10 in the state where the wear member 20 is in contact with the specimen 10 is not limited to the above example.

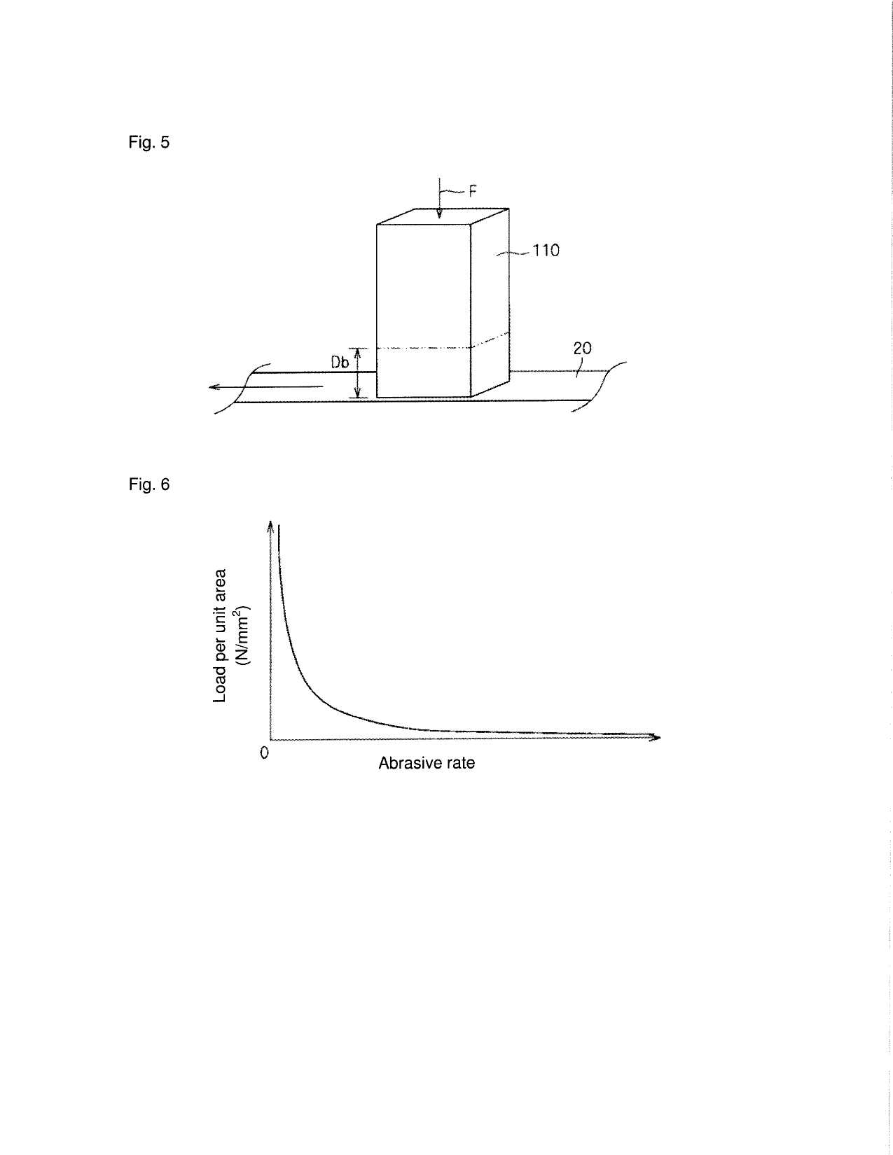

With reference to FIG. 5, for example, a columnar specimen 110 may be prepared. The specimen 110 may have a rectangular columnar shape, another polygonal columnar shape, or a cylindrical shape.

In a state where a bottom surface of the specimen 110 and the wear member 20 are opposite to and in contact with each other in a direction along a longitudinal direction of the columnar specimen 110, the wear member 20 is pulled and moved. The specimen 110 may be moved instead. The wear member 20 is disposed on a receiving member on a flat surface.

The wear resistance test can be performed similar to the embodiment above in this case as well. In the present modification, in particular, the columnar specimen 10 is gradually abraded from the bottom surface. Thus, it is advantageous in that the volume V of a portion abraded by the wear member 20 can be readily obtained.

FIG. 6 illustrates an exemplary relationship between an abrasive rate ((Dimension Db abraded by the wear member 20)/(Relative movement amount of the wear member 20 with respect to the specimen 110)) and a load per unit area ((Test load F)/(Contact area S)) in the modification illustrated in FIG. 5. As shown in the drawing, the abrasive rate is correlated with the load per unit area. The volume V of the portion abraded by the wear member 20 is a value proportionate to a value of integral of ((Test load F)/(Contact area S)). In the formula above to obtain the wear coefficient, the coefficient is an inverse of the value. In order to eliminate the difference in the test load F, it is considered appropriate that the wear amount of the specimen 10 divided by the test load F is obtained to calculate the wear coefficient, in other words, that the wear coefficient obtained without consideration of the test load F is divided by the test load F to calculate the wear coefficient.

The present invention was described in detail above. The description above, however, is presented as an example in all aspects, and the preset invention is not limited thereby. It is considered that countless modifications not illustrated could be assumed without deviating from the scope of the present invention.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. A method of testing wear resistance of a wire coating material, the method comprising:
(a) preparing a wire coating material as a specimen;
(b) relatively moving a wear member with respect to the specimen in a state where the wear member is in contact with the specimen;
(c) obtaining a first value associated with a relative movement amount of the wear member with respect to the specimen in (b);
(d) obtaining a second value associated with a wear amount of the specimen in (b); and
(e) calculating a value that evaluates wear resistance by dividing the first value by the second value.

2. The method of testing the wear resistance of the wire coating material according to claim 1, wherein
in (b), a constant test load is exerted on the specimen and the wear member; and
in (d), a value is obtained as the second value by dividing the wear amount of the specimen by the test load.

3. The method of testing the wear resistance of the wire coating material according to claim 1, wherein
in (a), the specimen having a round bar shape is prepared; and
in (b), the wear member having a band shape is used; the wear member is fitted along a circumferential surface of a pressing member and the wear member is brought into contact with the specimen in a state where a width direction of the wear member is orthogonal to a longitudinal direction of the specimen; and in this state, the wear member is pulled from between the specimen and the circumferential surface to move the wear member relative to the specimen.

4. The method of testing the wear resistance of the wire coating material according to claim 1, wherein
in (a), the specimen having a columnar shape is prepared; and
in (b), the specimen and the wear member are opposite to and in contact with each other in a direction along a longitudinal direction of the specimen.

5. The method of testing the wear resistance of the wire coating material according to claim 2, wherein
in (a), the specimen having a round bar shape is prepared; and
in (b), the wear member having a band shape is used; the wear member is fitted along a circumferential surface of a pressing member and the wear member is brought into contact with the specimen in a state where a width direction of the wear member is orthogonal to a longitudinal direction of the specimen; and in this state, the wear member is pulled from between the specimen and the circumferential surface to move the wear member relative to the specimen.

6. The method of testing the wear resistance of the wire coating material according to claim 2, wherein
in (a), the specimen having a columnar shape is prepared; and
in (b), the specimen and the wear member are opposite to and in contact with each other in a direction along a longitudinal direction of the specimen.
